(19) United States
(12) Patent Application Publication
(10) Pub. No.: US 2018/0188110 A1
(43) Pub. Date: Jul. 5, 2018

(54) FABRY-PEROT SPECTROMETER APPARATUS AND METHODS

(71) Applicant: VERIFOOD, LTD., Herzliya (IL)

(72) Inventors: Damian GOLDRING, Tel-Aviv (IL); Elad HEIMAN, Tel-Aviv (IL); Idan BAKISH, Petah-Tikva (IL); Ittai NIR, Tel-Aviv (IL); Sagee ROSEN, Netzer Sireni (IL); Uri KINROT, Hod HaSharon (IL)

(21) Appl. No.: 15/857,283

(22) Filed: Dec. 28, 2017

Related U.S. Application Data
(60) Provisional application No. 62/440,061, filed on Dec. 29, 2016.

(51) Int. Cl. G01J 3/26; G01J 3/02

(52) U.S. Cl. CPC G01J 3/26; G01J 3/0213; G01J 3/0205

(57) ABSTRACT

Apparatus and methods for providing an improved Fabry-Perot interferometer (FPI)-based spectrometer are disclosed herein. The improved FPI-based spectrometer may comprise one or more of a variety of improvements to allow improved sensitivity while retaining high spectral resolution, to limit the susceptibility to stray light, and to limit the degradation in performance due to temporal instabilities in the light source.

### CROSS-REFERENCE

The present application claims priority to U.S. Provisional Patent Application No. 62/440,061, entitled “IMPROVED FABRY-PEROT SPECTROMETER SYSTEMS AND METHODS”, filed Dec. 29, 2016, which application is herein incorporated by reference in its entirety for all purposes.

### BACKGROUND OF THE INVENTION

The Fabry-Perot interferometer (FPI) is an optical device which utilizes the principle of optical interference to allow transmission of light at a particular wavelength. An FPI typically comprises two flat parallel mirrors separated by a distance. Light incident on the first mirror is transmitted beyond the second mirror when its wavelength matches a resonant mode, which is determined by properties of the interferometer such as mirror spacing, mirror reflectivity, and angle of incidence. The space between the mirrors, often referred to as the resonant cavity, may be filled by vacuum, air, or another material.

The resonance conditions of an FPI may be varied in a variety of manners, such as by altering the spacing of the mirrors using, for instance, microelectromechanical systems (MEMS) techniques or by altering the properties of the material within the resonant cavity, such as by changing the temperature of a filling gas or by inducing a strain in a solid-state filling material. In this manner, the properties of the FPI and therefore the resonant wavelength may be changed as desired. This allows the successive transmission of many different wavelengths of light.

The FPI is used in a wide range of applications which require the precise control or measurement of optical wavelengths. For instance, FPI find extensive use in laser light generation, optical filtering, telecommunications, chemical spectroscopy, astronomical studies, and gravitational wave detection. Fabry-Perot interferometers also may be used in spectrometers as optical filters to generate high-resolution spectra.

Prior FPI-based spectrometers can be less than ideal in a number of respects. For example, operation of a prior FPI-based spectrometer can involve an unfavorable tradeoff between sensitivity and resolution, since increasing the numerical aperture (NA) of an FPI improves its sensitivity while degrading its spectral resolution. Further, it can be difficult to control the incident angle of incoming light into an FPI-based spectrometer, and thus stray light at wavelengths other than the particular desired wavelength may be transmitted to the FPI. As a result, the FPI may transmit polychromatic light rather than substantially monochromatic light, reducing the spectral resolution of the spectrometer. In addition, instabilities in components of the spectrometer, such as fluctuations in the spectral output of the illumination light source, can degrade performance of an FPI-based spectrometer.

In light of the above, an improved FPI-based spectrometer that overcomes at least some of these deficiencies would be beneficial. Ideally, such an improved FPI-based spectrometer would reduce the tradeoff between sensitivity and spectral resolution, be less susceptible to problems caused by stray light, and/or be more robust to instabilities in device components.

### SUMMARY OF THE INVENTION

Apparatus and methods for providing an improved Fabry-Perot interferometer (FPI)-based spectrometer are disclosed herein. The improved FPI-based spectrometer may comprise one or more of a variety of improvements to allow improved sensitivity while retaining high spectral resolution, to limit the susceptibility to stray light, and to limit the degradation in performance due to temporal instabilities in the light source.

In a first aspect, a spectrometer for measuring spectra of a sample may comprise: a Fabry-Perot interferometer configured to selectively transmit optically filtered light having a predetermined central wavelength; a detector configured to receive the optically filtered light from the Fabry-Perot interferometer and measure an intensity of the optically filtered light; and an angle-limiting layer disposed between the sample and the Fabry-Perot interferometer, the angle-limiting layer configured to receive light from the sample and transmit light having an angle of incidence within a predetermined range.

The angle-limiting layer may comprise a micro-louver film having a plurality of light transmissive sections and a plurality of light blocking sections arranged alternating along a length of the micro-louver film, wherein one or more of a thickness of the micro-louver film and a distance between adjacent light blocking sections are configured to selectively transmit the light having the angle of incidence within the predetermined range. The angle-limiting layer may comprise a prism film having an input surface configured to receive light and an output surface configured to output the light, the output surface comprising a plurality of microstructures configured to modify an angle of transmission of the output light, such that the output light comprises the light having the angle of incidence within the predetermined range.

The spectrometer may further comprise diffuser layer disposed between the sample and the angle-limiting layer, the diffuser layer configured to spatially distribute the light from the sample substantially evenly across an area of the angle-limiting layer. The spectrometer may further comprise a lens disposed between the Fabry-Perot interferometer and the detector, the lens configured to direct the optically filtered light towards the detector.

In a second aspect, a spectrometer for measuring spectra of a sample may comprise: a light source configured to emit illumination light towards the sample; a Fabry-Perot interferometer disposed between the light source and the sample, the Fabry-Perot interferometer configured to selectively transmit optically filtered illumination light having a predetermined central wavelength; and a detector configured to receive a portion of the optically filtered illumination light reflected by the sample, and measure an intensity of the reflected light.

The light source may comprise a broadband light source and the detector may comprise a broadband detector. The Fabry-Perot interferometer may be configured to scan through a plurality of predetermined central wavelengths of the illumination light to illuminate the sample with a series of optically filtered illumination light beams having the plurality of predetermined central wavelengths.

The spectrometer may further comprise a lens disposed between the light source and the Fabry-Perot interferometer, the lens configured to direct the illumination light towards the Fabry-Perot interferometer. The spectrometer may further comprise a second detector and a beam splitter, the beam splitter disposed between the Fabry-Perot interferometer and the sample and configured to transmit a first portion of the optically filtered illumination light towards the sample and reflect a second portion of the optically filtered illumination light away from the sample and towards the second detector, and the second detector configured to measure an intensity of the second portion of the optically filtered illumination light. The spectrometer may further comprise a processor operably coupled with the light source and the second detector, and configured with instructions to calibrate the light source in response to the intensity of the second portion of the optically filtered illumination light measured by the second detector.

In a third aspect, a spectrometer for measuring spectra of a sample may comprise: a Fabry-Perot interferometer configured to receive light from the sample and selectively transmit optically filtered light having a predetermined central wavelength; and a plurality of detectors configured to receive the optically filtered light transmitted through the Fabry-Perot interferometer, each detector of the plurality of detectors configured to receive a portion of the optically filtered light that is different from portions of the optically filtered light received by other detectors of the plurality of detectors.

Each detector of the plurality of detectors may have a size that is different from other detectors of the plurality of detectors to receive the portion of the optically filtered light that is within a range of incident angles that is different from ranges of incident angles of the portions of the optically filtered light received by other detectors of the plurality of detectors. The plurality of detectors may be disposed overlappingly in an optical path of the optically filtered light transmitted through the Fabry-Perot interferometer.

The spectrometer may further comprise a plurality of angle-limiting layers disposed between the Fabry-Perot interferometer and the plurality of detectors, each angle-limiting layer of the plurality of angle-limiting layers operably coupled to each detector of the plurality of detectors and configured to selectively transmit optically filtered light having an incidence angle within a predetermined range that is different from predetermined ranges of incident angles selectively transmitted by other angle-limiting layers of the plurality of angle-limiting layers. Each detector of the plurality of detectors may be configured to receive the portion of the optically filtered light that comprises a wavelength that is different from wavelengths of the portions of the optically filtered light received by other detectors of the plurality of detectors.

In a fourth aspect, a spectrometer for measuring spectra of a sample may comprise: an aperture layer configured to allow a portion of input light from the sample to pass through; a Fabry-Perot interferometer configured to receive the portion of the input light from the sample that has passed through the aperture layer and selectively transmit optically filtered light having a predetermined central wavelength; and a detector configured to receive the optically filtered light from the Fabry-Perot interferometer and measure an intensity of the optically filtered light, wherein the aperture layer is adjustable to adjust a numerical aperture of the detector.

The aperture layer may define an entrance aperture through which the portion of the input light from the sample is allowed to pass, wherein the aperture layer is further configured to adjust a size of the entrance aperture to adjust the numerical aperture of the detector. The aperture layer may comprise a mechanical or electromechanical shutter disposed over the entrance aperture and configured to adjust the size of the entrance aperture. The aperture layer may be coupled to a movable member that is movable to adjust a distance between the aperture layer and the detector, thereby adjusting the numerical aperture of the detector.

In a fifth aspect, a spectrometer for measuring spectra of a sample may comprise: a light source configured to direct a modulated optical beam to the sample; a Fabry-Perot interferometer configured to receive a portion of the modulated optical beam reflected by the sample and selectively transmit optically filtered light having a predetermined central wavelength; a detector configured to measure the optically filtered light from the Fabry-Perot interferometer to generate a measurement signal; and circuitry coupled to the light source and the detector, the circuitry configured to modulate the optical beam at a modulation frequency away from a noise frequency corresponding to noise or ambient light and filter the measurement signal for the modulation frequency.

The circuitry may be configured to modulate the optical beam at the modulation frequency away from 50 to 60 Hz and multiples thereof. The circuitry may be configured to modulate the optical beam at the modulation frequency away from a 1/f noise pattern. The circuitry may be further configured to measure ambient light to determine the noise frequency corresponding to ambient light.

In a sixth aspect, a method of measuring spectra of a sample with a spectrometer may comprise: modulating an optical beam to be emitted by a light source at a modulation frequency away from a noise frequency corresponding to noise or ambient light; directing the modulated optical beam from the light source towards the sample; transmitting a portion of the modulated optical beam reflected by the sample through a Fabry-Perot interferometer configured to selectively transmit optically filtered light having a predetermined central wavelength; measuring the optically filtered light with a detector to generate a measurement signal; and filtering the measurement signal for the modulation frequency.

The optical beam may be modulated at the modulation frequency away from 50 to 60 Hz and multiples thereof. The optical beam may be modulated at the modulation frequency away from a 1/f noise pattern. The method may further comprise measuring ambient light to determine the noise frequency corresponding to ambient light.

In a seventh aspect, a spectrometer for measuring spectra of a sample may comprise: a light source configured to emit an optical beam towards the sample; a Fabry-Perot interferometer configured to receive a portion of the optical beam reflected by the sample, and selectively transmit optically filtered light having a predetermined central wavelength; a detector configured to measure the optically filtered light from the Fabry-Perot interferometer to generate a measurement signal; and circuitry coupled to the light source and the detector, the circuitry configured to determine temporal deviations of the optical beam emitted by the light source and adjust one or more of the measurement signal generated by the detector and a power supplied to the light source in response to the temporal deviations of the optical beam.

The spectrometer may further comprise a temperature sensor operably coupled to the light source and the circuitry, the temperature sensor configured to measure a temperature of the light source over time, wherein the circuitry is configured to determine the temporal deviations of the optical beam in response to deviations in the temperature of the light source over time. The spectrometer may further comprise a second detector coupled to the circuitry and configured to measure the optical beam emitted from the light source towards the sample, the circuitry configured to determine the temporal deviations of the optical beam in response to measurements made by the second detector. The spectrometer may further comprise a short pass filter optically coupled to the second detector, a third detector coupled to the circuitry, and a long pass filter optically coupled to the third detector, wherein the second detector is configured to measure a first portion of the optical beam transmitted through the short pass filter and the third detector is configured to measure a second portion of the optical beam transmitted through the long pass filter. The circuitry may be configured to determine the temporal deviations of the optical beam in response to a total power output of the light source over time and a ratio of power output of the first portion to the second portion of the optical beam over time. The spectrometer may further comprise a voltage meter operably coupled to the light source and the circuitry, the voltage meter configured to measure a voltage drop across the light source over time, wherein the circuitry is configured to determine the temporal deviations of the optical beam in response to deviations in the voltage drop across the light source over time.

In an eight aspect, a method of measuring spectra of a sample may comprise: directing an optical beam from a light source towards the sample; transmitting a portion of the optical beam reflected by the sample through a Fabry-Perot interferometer configured to selectively transmit optically filtered light having a predetermined central wavelength; measuring the optically filtered light with a detector to generate a measurement signal; determining temporal deviations of the optical beam emitted by the light source; and adjusting one or more of the measurement signal generated by the detector and power supplied to the light source in response to the temporal deviations of the optical beam.

The method may further comprise measuring a temperature of the light source over time with a temperature sensor, wherein the temporal deviations of the optical beam are determined in response to deviations in the temperature of the light source over time. The method may further comprise measuring the optical beam emitted from the light source towards the sample with a second detector, wherein the temporal deviations of the optical beam are determined in response to measurements made by the second detector. Measuring the optical beam with the second detector may comprise measuring a first portion of the optical beam with the second detector, and the method may further comprise measuring a second portion of the optical beam with a third detector, wherein the first portion of the optical beam is transmitted through a short pass filter prior to detection with the second detector, and the second portion of the optical beam is transmitted through a long pass filter prior to detection with the third detector. The temporal deviations of the optical beam may be determined in response to a total power output of the light source over time and a ratio of power output of the first portion to the second portion of the optical beam over time. The method may further comprise measuring a voltage drop across the light source over time with a voltage meter, wherein the temporal deviations of the optical beam are determined in response to deviations in the voltage drop across the light source over time.

In a ninth aspect, a method of measuring spectra of a sample may comprise: scanning through a sequence of a plurality of central wavelengths of light using a tunable Fabry-Perot interferometer configured to receive input light from the sample; and measuring the light transmitted through the Fabry-Perot interferometer with a detector to generate the spectra of the sample comprising the plurality of central wavelengths of light, wherein the sequence of the plurality of central wavelengths of light comprises repeated scans of a reference wavelength at various time points of the scanning.

In a tenth aspect, a spectrometer for measuring spectra of a sample may comprise: a Fabry-Perot interferometer configured to selectively transmit optically filtered light having a predetermined central wavelength; a detector configured to receive the optically filtered light from the Fabry-Perot interferometer and measure an intensity of the optically filtered light; and an angle-limiting structure disposed between the sample and the Fabry-Perot interferometer, the angle-limiting layer configured to receive light from the sample and transmit light having an angle of incidence within a predetermined range.

The structure may comprise an angle-limiting filter. An internal wall of a housing of the spectrometer may be coated with a diffusive cover which both absorbs most of an incident light and scatters the rest of the incident light. The diffusive cover may be made from a light-absorbing material or a light-diffusive material. A gap between the detector and the Fabry-Perot interferometer may be encapsulated. The gap between the detector and the Fabry-Perot interferometer may be encapsulated by a mounted shield. The gap between the detector and the Fabry-Perot interferometer may be encapsulated by an opaque glue.

In an eleventh aspect, a spectrometer for measuring spectra of a sample may comprise: a Fabry-Perot interferometer configured to selectively transmit optically filtered light having a predetermined central wavelength; a detector configured to receive the optically filtered light from the Fabry-Perot interferometer and measure an intensity of the optically filtered light; and additional optomechanics above the Fabry-Perot interferometer, wherein the additional optomechanics comprise a housing and an optics, the housing having an upper aperture and a lower aperture, the optics being provided above the lower aperture to receive light from the sample and transmit light having an angle of incidence within a predetermined range.

An internal wall of the housing of the additional optomechanics may be coated with a diffusive cover which both absorbs most of an incident light and scatters the rest of the incident light. The diffusive cover may be made from a light-absorbing material or a light-diffusive material. The detector may comprise two or more photodiodes at close proximity, each one of the two or more photodiodes sensing one order of the Fabry-Perot interferometer, and the two or more photodiodes together covering a full spectral range during one scanning period. The two or more photodiodes may have different spectral ranges from each other. The spectral range of the two or more photodiodes may overlap. The sample may be illuminated with two or more illumination sources, each one of the two or more illumination sources comprising a different order-sorting filter covering the spectral range of different orders of the Fabry-Perot interferometers. The two or more illumination sources may operate intermittently, with a collected signal corresponding to the order of the operated illumination source at any given time. The two or more illumination sources may operate at the same time and may be modulated to different frequencies, with a signal from the detector being filtered by two different band-pass filters to separate the two or more orders. The band-pass filters may be implemented with analog or digital circuitry. The two or more illumination sources may have different spectral ranges from each other. Spectral ranges of the two or more illumination sources may overlap. The sample may be illuminated with a single illumination source with multiple order sorting filters alternating during a sampling period.

These and other embodiments are described in further detail in the following description related to the appended drawing figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A schematically illustrates the transmission of light in a prior FPI-based spectrometer under ideal conditions;

FIG. 1B shows an optical transmission spectrum of the prior FPI-based spectrometer of FIG. 1A;

FIG. 2A schematically illustrates the transmission of light in a prior FPI-based spectrometer under typical conditions;

FIG. 2B shows an optical transmission spectrum of the prior FPI-based spectrometer of FIG. 2A;

FIG. 3A shows an improved FPI-based spectrometer comprising an angle-limiting layer;

FIG. 3B schematically illustrates the transmission of light through an exemplary embodiment of the angle-limiting layer of FIG. 3A;

FIG. 3C schematically illustrates the transmission of light through another exemplary embodiment of the angle-limiting layer of FIG. 3A;

FIG. 4A shows an improved FPI-based spectrometer comprising a diffuser layer and an angle-limiting film;

FIG. 4B schematically illustrates the transmission of light in the improved FPI-based spectrometer of FIG. 4A;

FIG. 5 shows an improved FPI-based spectrometer comprising a lens disposed between the FPI and the detector;

FIG. 6A shows an improved FPI-based spectrometer comprising an FPI configured to filter an illumination light source;

FIG. 6B shows the improved FPI-based spectrometer of FIG. 6A further comprising a beamsplitter between the FPI and the sample;

FIG. 7A shows an improved FPI-based spectrometer comprising a plurality of detectors having different sizes;

FIG. 7B shows an improved FPI-based spectrometer comprising a plurality of detectors positioned at different locations and configured to receive light over different ranges of incident angles;

FIG. 7C shows optical transmission spectra of an improved FPI-based spectrometer as in FIG. 7A or 7B, configured to measure light at a plurality of different spectral resolutions;

FIGS. 8A and 8B show an improved FPI-based spectrometer comprising a variable NA aperture that is movable with respect to the detector;

FIG. 9 shows an improved FPI-based spectrometer comprising a case coated with a diffusive black material;

FIG. 10 shows an improved FPI-based spectrometer comprising additional optomechanics;

FIG. 11 shows an exemplary method for improving a measurement signal obtained with an FPI-based spectrometer by modulating the illumination light;

FIG. 12 shows an exemplary method for tracking temporal deviations of the illumination light source of an FPI-based spectrometer; and

FIGS. 13A-13C show exemplary scan patterns for obtaining sample spectra using an FPI-based spectrometer.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figures and described in the specification, but only as indicated in the accompanying claims, with the proper scope determined only by the broadest interpretation of said claims.

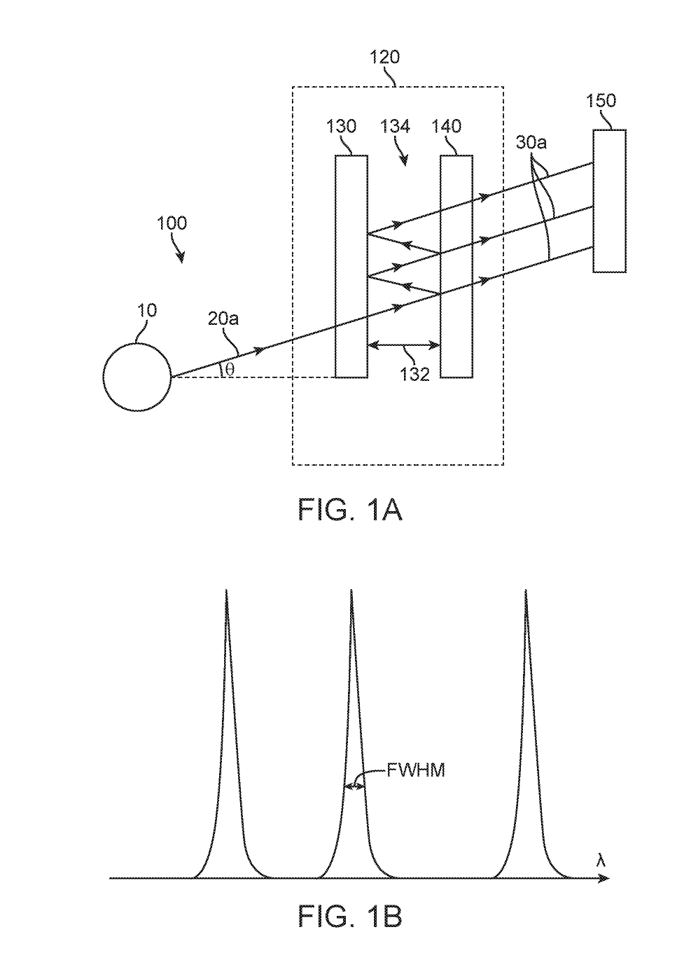

FIG. 1A schematically illustrates the transmission of light in a prior FPI-based spectrometer under ideal conditions. The FPI-based spectrometer 100 may comprise a Fabry-Perot interferometer (FPI) 120 and a detector 150, wherein the FPI is configured to function as an optical filter for the spectrometer. The FPI 120 may comprise a first mirror 130 and second mirror 140 separated by a distance 132, to define a resonant cavity 134 therebetween. The spectrometer may be used to measure a sample 10, wherein sample light 20a emanating from the sample enters the resonant cavity 134 at an angle θ to the normal. The first mirror 130 and the second mirror 140 may each comprise a partially reflective internal surface, such that light entering the cavity undergoes multiple reflections and transmissions at each of the two mirrors, producing multiple beam interference. The multiple beams interfere constructively and are transmitted out of the cavity 134 when the optical wavelength λ meets a resonance condition:

$$λ = \frac{2 nl cos θ}{m} \qquad ( Eq . 1 )$$

Here, n is the index of refraction in the cavity, l is the spacing between the two mirrors, θ is the angle of incidence, and m is an integer. Thus, the cavity transmits discrete wavelengths determined by the properties of the cavity and the angle of incidence θ. The cavity may be tunable by a variety of means, such as varying the spacing between mirrors or by altering the properties of the material within the resonant cavity. In this way, the cavity may be configured to selectively pass light having an optical wavelength within a desired range. Under ideal conditions, the sample light 20a is highly collimated such that it is incident on the FPI at a single angle. In such ideal operating conditions, the FPI may transmit only a single wavelength of the sample light and its integer submultiples. The light 30a exiting the cavity 134 can therefore be nearly monochromatic. The optically filtered output light 30a exiting the FPI may be detected by the detector 150, which comprises any suitable photodetector known in the art.

FIG. 1B shows an optical transmission spectrum of the prior FPI-based spectrometer of FIG. 1A. The transmission efficiency reaches its maximum value at the resonant wavelengths described in Eq. 1. The linewidth of the transmission maximum is determined by the reflectivities of the mirrors making up the resonant cavity. An ideal FPI may display a wavelength selectivity greater than one part in 10⁶, where selectivity is defined as the ratio of the linewidth (such as the full width at half maximum linewidth, FWHM) to the central transmission wavelength. Thus, the FPI can function as an extremely selective optical filter under ideal measurement conditions.

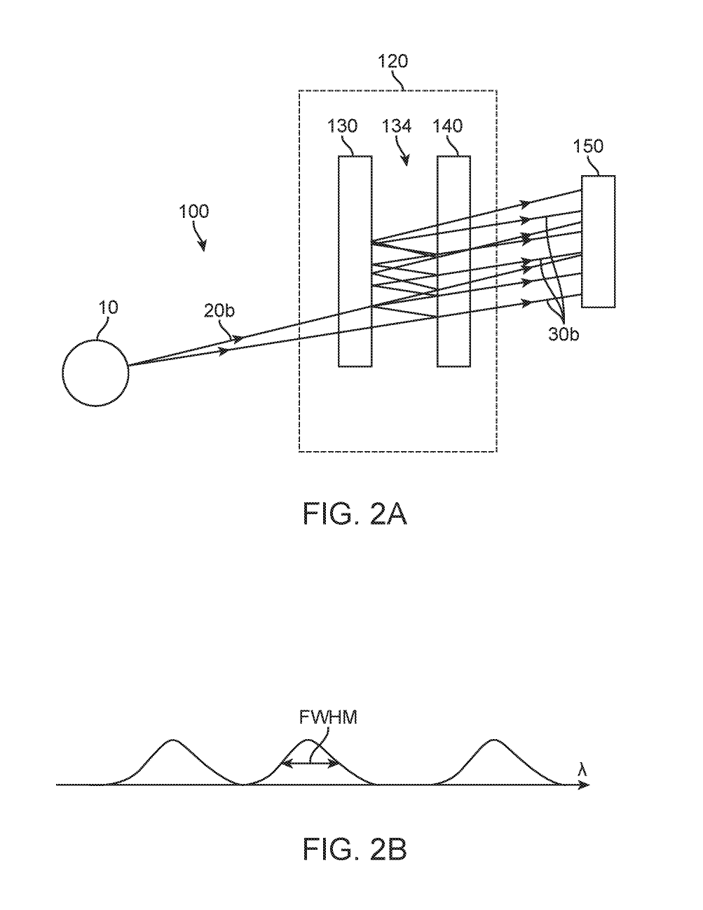

FIG. 2A schematically illustrates the transmission of light in a prior FPI-based spectrometer under typical conditions. The FPI-based spectrometer 100 can be similar in many aspects to the spectrometer 100 of FIG. 1A. The spectrometer 100 may comprise an FPI 120 and a detector 150, wherein the FPI 120 comprises a first mirror 130 and a second mirror 140 separated by a distance to form a resonant cavity 134 therebetween. The spectrometer 100 may be used to measure light 20b emanating from a sample 10, wherein the light 20b is optically filtered via selective transmission through the FPI 120, and the filtered light 30b is subsequently detected by the detector 150. Under typical, real-life operating conditions, the sample light 20b is generally partially collimated with some angular divergence. The partially collimated sample light 20b thus enters the cavity 134 with a distribution of incident angles. Referring to Eq. 1, this leads to the transmission of a distribution of wavelengths. A divergence of even one degree of arc in the sample light 20b may degrade the wavelength selectivity of the FPI to approximately one part in 3*10⁴, or nearly two orders of magnitude worse than in the ideal case of perfectly collimated light. Thus, the FPI is a less selective optical filter in the presence of imperfectly collimated light. The light 30b emerging from the FPI in this case is thus more highly polychromatic light. Under typical conditions, perfect collimation of an extended broadband light source is difficult to achieve due to the conservation of etendue. An FPI used to select particular wavelengths from a broadband light source may therefore be degraded in performance by light impinging upon the cavity at multiple angles.

FIG. 2B shows an optical transmission spectrum of the prior FPI-based spectrometer of FIG. 2A. The transmission efficiency now reaches its maximum value at a distribution of wavelengths corresponding to a distribution of incident angles, as described in Eq. 1. The overall transmission function is a superposition of the narrow transmission functions associated with each of the transmitted wavelengths. This results in a substantial broadening of the transmission functions. An FPI operating under typical conditions, with a beam divergence of even one degree of arc, may display a wavelength selectivity of only one part in 3*10⁴. Thus, the FPI subject to imperfectly collimated light forms a far less selective optical filter than an FPI receiving perfectly collimated input light. Thus, the optical selectivity of the FPI in a spectrometer system may be comprised when the sample light impinges upon the FPI at diverging incidence angles.

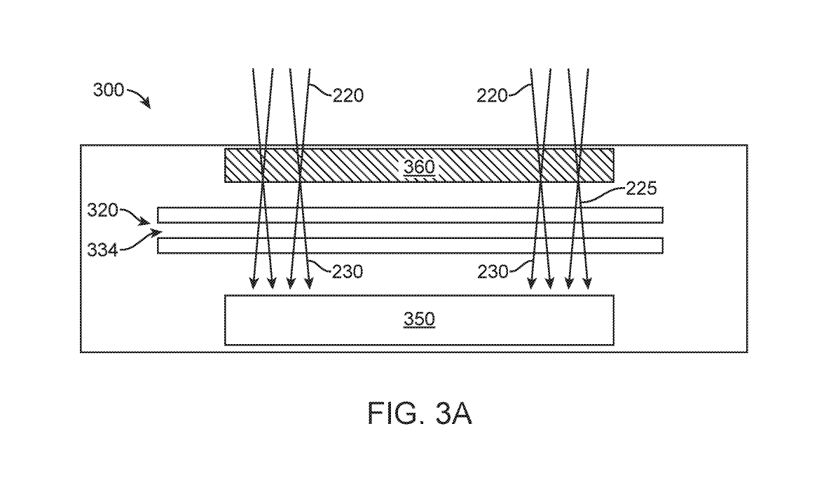

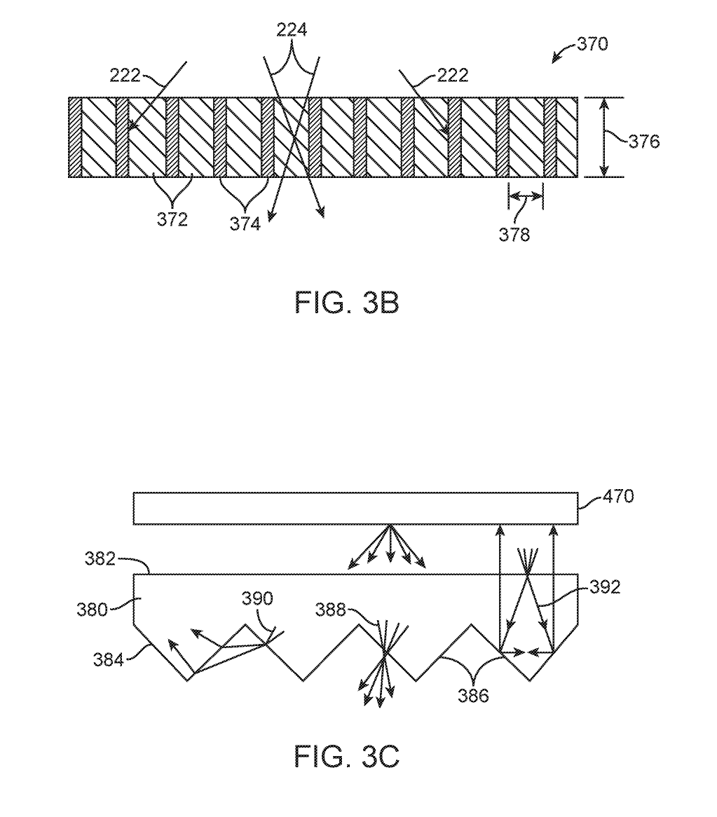

FIG. 3A shows an improved FPI-based spectrometer 300 comprising an angle-limiting layer 360. The spectrometer 300 may comprise an FPI 320 configured to receive light from the sample and transmit optically filtered light, a detector 350 configured to measure the optically filtered light transmitted through the FPI, and an angle-limiting layer 360 disposed between the FPI and the sample. FPI 320 may be similar in many aspects to FPI 120 shown in FIGS. 1A-2B and may comprise similar components and features. Detector 350 may be similar in many aspects to detector 150 shown in FIGS. 1A-2B and may comprise similar components and features. The angle-limiting layer 360 may receive light 220 emanating from the sample. The angle-limiting layer may act to prevent light rays from entering the cavity 334 of the FPI unless the light rays approach the FPI at an angle of incidence defined by the acceptance cone of the angle-limiting film. In such a manner, the angle-limiting layer may transmit only light 225 which falls within a predetermined range of angles of incidence. The light 225 leaving the angle-limiting layer may impinge upon the FPI 320. Light 230 having a predetermined central wavelength may be transmitted out of the FPI according to Eq. 1, as discussed in reference to FIGS. 1A-2C. In this manner, the FPI-based spectrometer comprising an angle-limiting layer disposed between the sample and the FPI may provide improved spectral resolution of the sample light by reducing the transmission of multiple wavelengths of light associated with a broad range of incident angles. The angle-limiting layer can be either a part of the housing of the spectrometer, or can be attached to the incident light entrance of the housing.

FIG. 3B schematically illustrates the transmission of light through an exemplary embodiment of the angle-limiting layer of FIG. 3A. The angle-limiting layer may comprise a micro-louver film 370. The micro-louver film 370, having a thickness 376, may comprise a plurality of light transmissive sections 372 and a plurality of light blocking sections (“louvers”) 374, arranged alternatingly along a length of the micro-louver film. Adjacent light blocking sections or louvers may be separated by a distance 378. The light transmissive sections can allow light to pass therethrough, while the light blocking sections can substantially absorb incident light. Light 222 entering a light transmissive section of the micro-louver film at a large angle outside of the predetermined range of allowable angles can hit a light blocking section before exiting the micro-louver film, wherein the majority of the light may be absorbed by the light blocking section. Light 224 entering a light transmissive section at an angle within the predetermined allowable range can exit the micro-louver film without hitting a light blocking section, thereby passing through to the FPI.

The maximum angle of incidence of light allowed to pass through the micro-louver film may be calculated using the following equation:

$$α = {tan}^{- 1} \frac{D}{T} \qquad ( Eq . 2 )$$

Here, α is the maximum angle of incidence of light allowed to pass, D is the distance between adjacent light blocking sections, and T is the effective thickness of the micro-louver film, or the free-space thickness divided by the index of refraction of the film. Thus, the maximum allowed angle of incidence may be controlled by adjusting one or more of the thickness of the micro-louver film and the distance between adjacent light blocking sections.

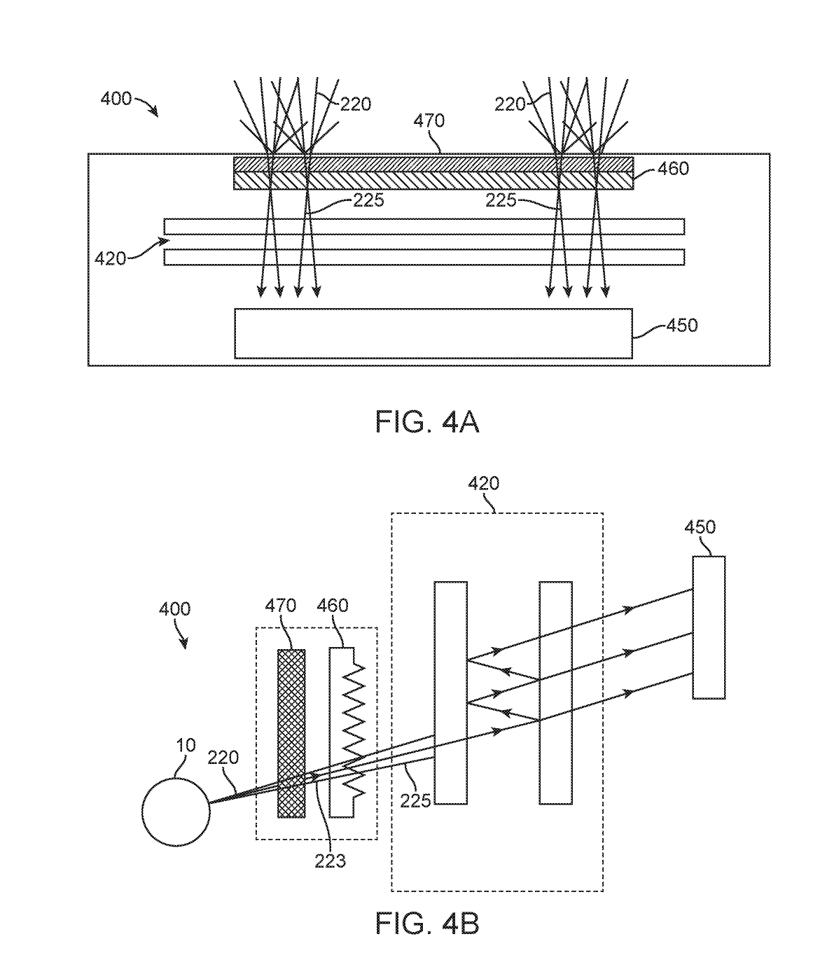

FIG. 3C schematically illustrates the transmission of light through another exemplary embodiment of the angle-limiting layer of FIG. 3A. The angle-limiting layer may comprise a prism film 380. The prism film may comprise an input surface 382 configured to receive light and an output surface 384 configured to output the light transmitted through the prism film. The output surface may comprise a plurality of microstructures 386, such as engineered microstructures on a polymeric film. The plurality of microstructures may comprise a plurality of pyramid shaped structures. The plurality of microstructures can be configured to guide the light entering the prism film at large angles to exit from the film at a smaller angle span. As light 388 that has entered the prism film at a large angle exits through the microstructures, the angle of transmission of the output light can be modified by the microstructures, such that the output light selectively comprises light having an angle of incidence within a predetermined range of acceptable angles (e.g., −5° to 5° with respect to the normal to the plane of the prism film). At least some of the light that enters the prism film at an angle of incidence outside the predetermined acceptable range may be redirected or reflected, enabling reuse of the light and thereby helping to improve the efficiency of the spectrometer. For example, light 390 reaching a surface of a microstructure at a large angle may be redirected by the microstructure into an adjacent microstructure. Light 392 reaching a surface of a microstructure at a large angle may be reflected from the microstructure surface back towards an additional optical element, wherein the light may be recycled and fed back into the prism film. For example, the light 392 may be reflected back towards diffuser 470 (as described in further detail with reference to FIGS. 4A and 4B), wherein the light may be diffusely recycled and fed back into the prism film.

FIG. 4A shows an improved FPI-based spectrometer 400 comprising a diffuser layer 470 and an angle-limiting layer 460. The spectrometer 400 may comprise an FPI 420 configured to receive light from the sample and transmit optically filtered light, a detector 450 configured to measure the optically filtered light transmitted through the FPI, an angle-limiting layer 460 disposed between the FPI and the sample, and a diffuser layer 470 disposed between the angle-limiting layer and the sample. FPI 420 may be similar in many aspects to FPI 120 shown in FIGS. 1A-2B and may comprise similar components and features. Detector 450 may be similar in many aspects to detector 150 shown in FIGS. 1A-2B and may comprise similar components and features. Angle-limiting layer 460 may be similar in many aspects to angle-limiting layer 360 shown in FIGS. 3A-3C and may comprise a micro-louver film or a prism film, for example. The diffuser layer 470 may be configured to receive input light 220 from the sample and output diffuse light that is scattered over a wide range of exit angles. The diffuser layer may comprise, for example, a cosine diffuser having a substantially Lambertian distribution function, wherein the input light is scattered to all directions of the hemisphere above the output surface. Thus, the spatial variations in the intensity of light impinging upon the angle-limiting layer 460 may be reduced, accordingly reducing the sensitivity of the system to an uneven spatial distribution of the input light from the sample. The light 225 transmitted by the angle-limiting layer may then enter the FPI 420 with a substantially narrowed angular distribution. In this manner, the FPI-based spectrometer with a diffuser layer and an angle-limiting layer may both improve the uniformity of the spatial distribution of light passed through to the detector, and provide improved spectral resolution of the sample light by minimizing the transmission of multiple wavelengths of light associated with a broad range of incident angles.

FIG. 4B schematically illustrates the transmission of light in the improved FPI-based spectrometer 400 of FIG. 4A. Light 220 from the sample 10 may impinge upon the diffuser layer 470. The diffuser film may output diffuse light 223 over a wide range angles, softening any spatial variation in the intensity of light impinging on different locations of the diffuser layer. This wide cone of light may impinge on the angle-limiting layer 460, which may transmit light 225 falling within a predetermined range of incident angles, as described in reference to FIG. 3A.

The light 225 transmitted by the angle-limiting layer may then enter the FPI 420 with a substantially narrowed angular distribution, thereby improving the wavelength selectivity of the FPI-based spectrometer while reducing susceptibility of the system to uneven spatial distributions of the input light from the sample and improving the uniformity of the light passed through to the detector 450.

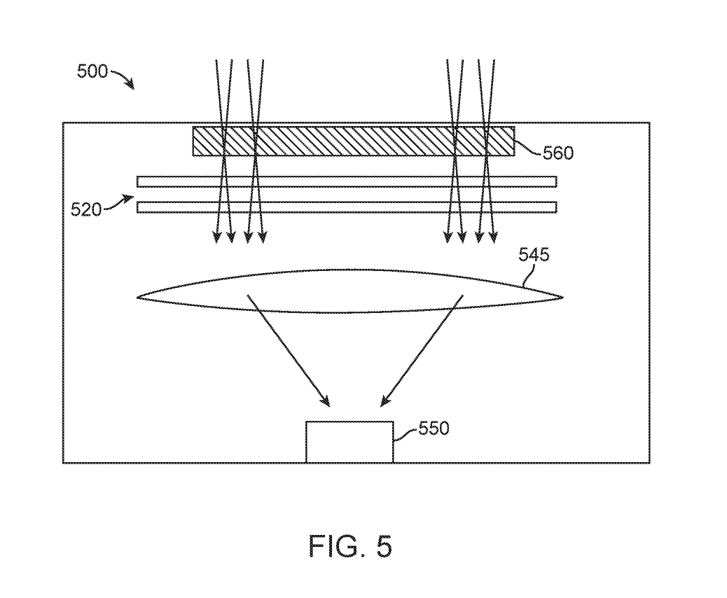

FIG. 5 shows an improved FPI-based spectrometer 500 comprising a lens 545 disposed between the FPI 520 and the detector 550. The spectrometer 500 may comprise an FPI 520 configured to receive input light from the sample and transmit optically filtered light, a detector 550 configured to measure the optically filtered light transmitted through the FPI, and a lens 545 disposed between the FPI and the detector. FPI 520 may be similar in many aspects to FPI 120 shown in FIGS. 1A-2B and may comprise similar components and features. Detector 550 may be similar in many aspects to detector 150 shown in FIGS. 1A-2B and may comprise similar components and features. The lens 545 may converge light transmitted by the FPI 520 onto a smaller area than would be possible in the absence of the lens. Thus, a physically smaller and less expensive detector 550 may be utilized. Optionally, a multi-lens system may be used in place of a single lens. Optionally, an angle-limiting layer 560 such as a micro-louver film or a prism film as described herein may be placed between the FPI 520 and the sample in order to reduce the range of incident angles of the light impinging upon the FPI. Optionally, a diffuser layer as described herein may be placed between the FPI 520 and the sample to improve the uniformity of the spatial distribution of input light detected by the detector.

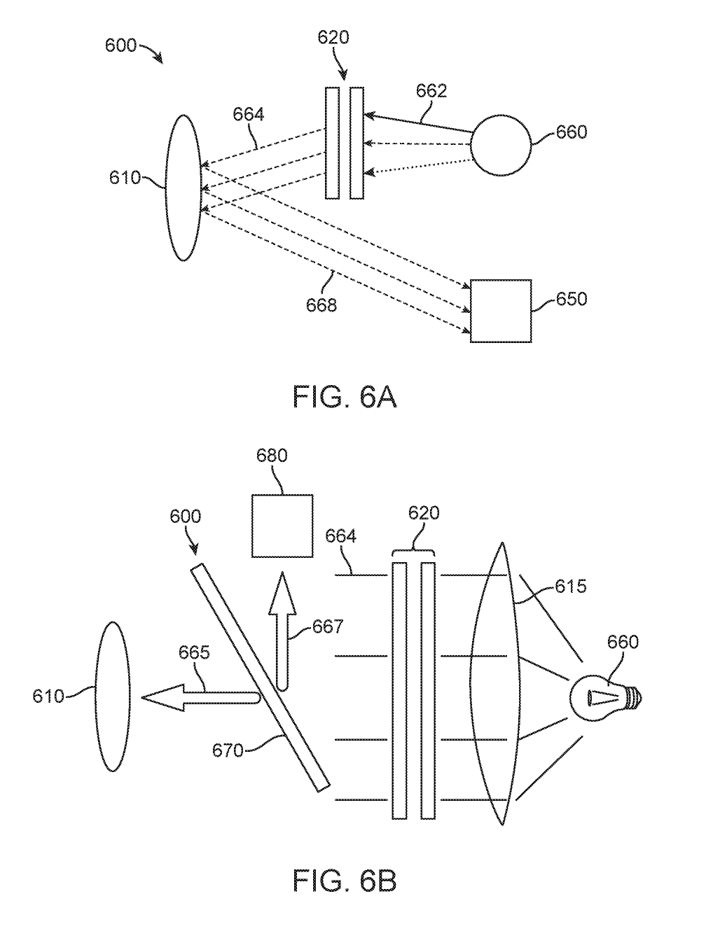

FIG. 6A shows an improved FPI-based spectrometer 600 comprising an FPI 620 configured to filter an illumination light beam 662 emitted by an illumination light source 660. The spectrometer 600 may comprise an illumination light source 660, an FPI 620 disposed between the illumination light source and the sample, and a detector 650. FPI 620 may be similar in many aspects to FPI 120 shown in FIGS. 1A-2B and may comprise similar components and features. Detector 650 may be similar in many aspects to detector 150 shown in FIGS. 1A-2B and may comprise similar components and features. The light source 660 may be configured to emit an illumination light beam 662 towards the sample 610. The FPI 620, positioned in the optical path of the illumination light 662 directed towards the sample 610, may selectively transmit optically filtered illumination light 664 having a predetermined central wavelength, as described herein. The optically filtered illumination light 664 may impinge upon the sample 610, and at least a portion of the light 668 reflected from the sample may then be detected by the detector 650. The light source 660 may comprise a broadband light source, and the detector 650 may comprise a broadband detector. By varying the transmitted wavelength of the illumination light (for instance, by varying the distance between the two mirrors of the FPI according to Eq. 1) and measuring the reflected light over the various transmitted wavelengths, a spectrum of the light reflected by the sample may be attained. The broadband detector may allow the use of a wide range of wavelengths.

FIG. 6B shows the improved FPI-based spectrometer 600 of FIG. 6A further comprising a beam splitter 670 disposed between the FPI 620 and the sample 610. The beam splitter 670 may be placed between the FPI 620 and a sample 610, in the optical path of the optically filtered illumination light beam 664 directed from the FPI to the sample. The beam splitter may split the light 664 from the FPI into a first portion 665 and a second portion 667, wherein the first portion is transmitted to the sample 610 and the second portion 667 is deflected away from the sample. The deflected light 667 may be directed towards an optional second detector 680, which may be configured to analyze the light to provide information about the operating parameters of the light source at any time. For instance, the measurement signal at second detector 680 may output the illumination intensity at each wavelength of the illumination light directed towards the sample. This information may then be used in post-processing to apply corrections to the information collected by the broadband detector. As another example, the measurement signal from second detector 680 may be used to provide on-the-fly feedback to the light source 660, such as through the use of a proportional-integral-derivative (PID) controller. The beam splitter 670 may be any type of beam splitter, including, but not limited to, beam splitters utilizing the principles of reflection, refraction, or birefringence. The beam splitter may deflect the path of transmitted light as well as that of the deflected light, as in a Wollaston prism. The beam splitter may produce any angle between the transmitted light and the deflected light. The system may further comprise a lens 615 that collimates light received from the light source 660.

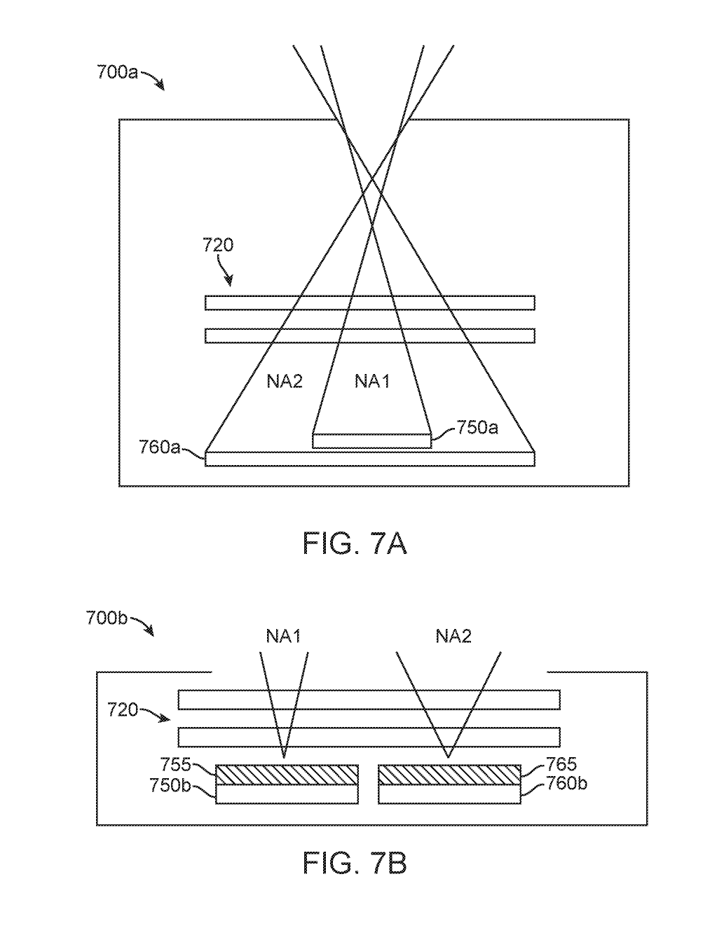

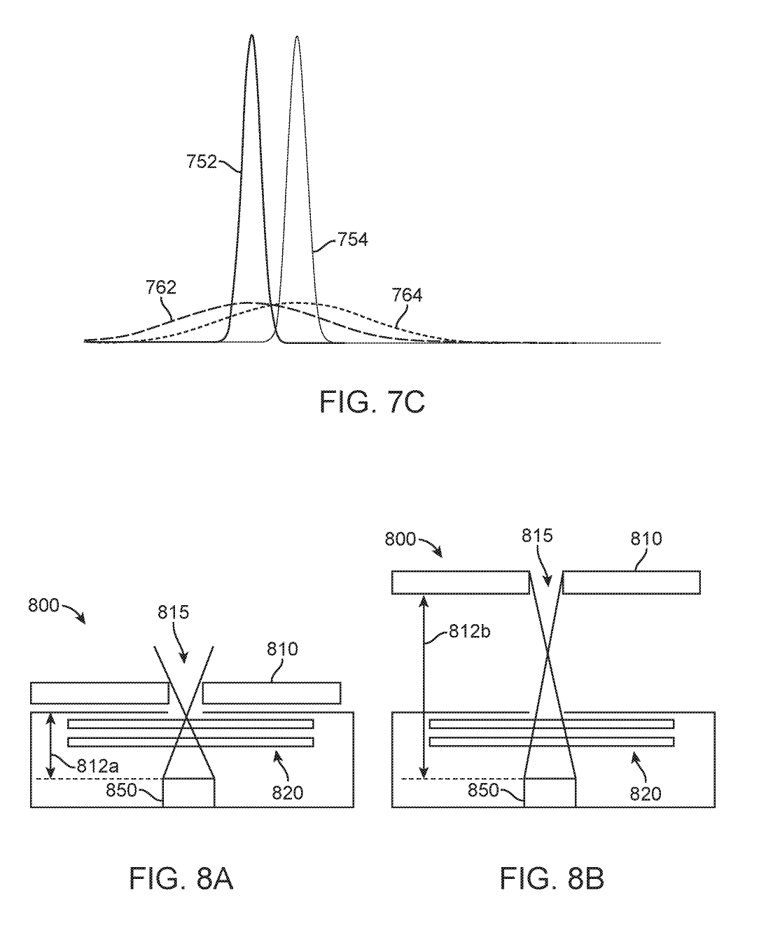

FIG. 7A shows an improved FPI-based spectrometer 700a comprising a plurality of detectors 750a, 760a having different sizes. The spectrometer 700a may comprise an FPI 720, a first detector 750a, and a second detector 760a. FPI 720 may be similar in many aspects to FPI 120 shown in FIGS. 1A-2B and may comprise similar components and features. Detectors 750a and 760a may be similar in many aspects to detector 150 shown in FIGS. 1A-2B and may comprise similar components and features. The first and second detectors may have different numerical apertures (NA), such that the detectors produce signals having different spectral resolutions. As shown, the first detector and the second detector may be positioned overlappingly in the optical path of the light. The first detector 750 may be smaller in size than the second detector 760. The smaller detector 750a may receive a relatively small amount of light with a relatively small NA, and therefore display relatively low sensitivity and high spectral resolution. The larger detector 760a may receive a relatively large amount of light with a relatively large NA, and therefore display a relatively high sensitivity and low spectral resolution. Both detectors 750a and 760a may receive light having the central wavelength corresponding to light impinging upon the FPI at the normal. The larger detector may receive light impinging at a greater angle and thus may receive additional blue-shifted light. As a result, redundant information in the signals of the two detectors may allow the collection of additional time-dependent data. This data may allow correction of changes in the operating parameters of the system over time. In some embodiments, more than two detectors may be utilized.

FIG. 7B shows an improved FPI-based spectrometer 700b comprising a plurality of detectors 750b, 760b positioned at different locations and configured to receive light over different ranges of incident angles. The spectrometer 700b may comprise an FPI 720, a first detector 750b, a second detector 760b, a first angle-limiting layer 755 optically coupled to the first detector, and a second angle-limiting layer 765 optically coupled to the second detector. FPI 720 may be similar in many aspects to FPI 120 shown in FIGS. 1A-2B and may comprise similar components and features. Detectors 750b and 760b may be similar in many aspects to detector 150 shown in FIGS. 1A-2B and may comprise similar components and features. Angle-limiting layers 755 and 765 may be similar in many aspects to angle-limiting layer 360 shown in FIGS. 3A-3C and may comprise, for example, a micro-louver film or a prism film as described. Detectors 750b and 760b may differ in NA and thus in the incident angles and wavelengths of light accepted. The first detector 750b may have relatively small NA, while the second detector 760b may have a relatively large NA. The two detectors may be positioned non-overlappingly in the optical path of the light, over different areas of the FPI 720. The NA of detectors 750b and 760b may be determined by angle-limiting films 755 and 765, respectively. Both detectors 750b and 760b may receive the central wavelength corresponding to light impinging upon the FPI at the normal. The second detector 760b with the larger NA may receive light impinging at a greater angle and thus may receive additional blue-shifted light. As a result, redundant information in the signals of the two detectors may allow the collection of additional time-dependent data. This data may allow correction of changes in the operating parameters of the system over time. In some embodiments, more than two detectors may be utilized.

FIG. 7C shows optical transmission spectra of an improved FPI-based spectrometer as in FIG. 7A or 7B, configured to measure light at a plurality of different spectral resolutions. The first detector with the smaller NA may produce a signal 752 with a narrow full width half maximum (FWHM) at a first wavelength λ₁ and a signal 754 with a narrow FWHM at a second wavelength λ₂, thus having relatively high spectral resolution at the first and second wavelengths. The first detector may be sensitive to a first wavelength λ₁ at a first time point of measurement and to a second wavelength λ₂ at a second time point of measurement. The second detector with the larger NA may produce a signal 762 with a wide FWHM at a first wavelength λ₁ and a signal 764 with a wide FWHM at a second wavelength λ₂, thus having relatively low spectral resolution at the first and second wavelengths. The second detector may be sensitive to a first wavelength λ₁ and to a second wavelength λ₂ at both the first time point and the second time point. Each detector may measure a signal which is the product of a wavelength-dependent component and a time-dependent component. The first detector may be configured to detect an intensity I(λ₁) at a first wavelength λ₁ at a first time point and an intensity I(λ₂) at a second wavelength λ₂ at a second time point. The second detector may be configured to detect an intensity I(λ₁)+I(λ₂) at both the first wavelength λ₁ and the second wavelength λ₂ at a first time point and an intensity I(λ₁)+I(λ₂) at both the first wavelength λ₁ and the second wavelength λ₂ at a second time point. The first and second detectors may be subject to a time-dependent response factor R(t) at a first time point and a time-dependent response factor R(t+Δt) at a second time point. Thus, the first detector may measure a signal D_{narrow} (t) at a first time point and a signal D_{narrow} (t+Δt) at a second time point while the second detector measures a signal D_{wide}(t) at a first time point and a signal D_{wide}(t+Δt) at a second time point:

D_{narrow}(t)∝I(λ₁)·R(t),D_{wide}(t)∝(I(λ₂))·R(t)

D_{narrow}(t+Δt)∝I(λ₂)·R(t+Δt),D_{wide}(t+Δt)∝(I(λ₁)+I(λ₂))·R(t+Δt) (Eq. 3)

The ratio of R(t+Δt) to R(t) may be estimated by measurements of D_{wide}(t+Δt) and D_{wide}(t) according to Eq. 3. This ratio may then be applied to measurements of D_{narrow}(t+Δt) and D_{narrow}(t) to obtain an estimate of the ratio of I(λ₂) to I(λ₁) according to Eq. 3. This has the effect of decoupling the time-varying response of the measurement system. This technique may allow the removal of time-varying signals due to effects such as shadowing, vibrations, and instabilities in distances between system components. In such a technique, the first detector achieves high spectral resolution while the second detector achieves correlation between adjacent measurements.

FIG. 8A and FIG. 8B show an improved FPI-based spectrometer 800 comprising an aperture layer 810 that is movable with respect to the detector. The spectrometer 800 may comprise an FPI 820, detector 850, and an aperture layer 810. FPI 820 may be similar in many aspects to FPI 120 shown in FIGS. 1A-2B, and detector 850 may be similar in many aspects to detector 150 shown in FIGS. 1A-2B. The aperture layer 810 may define an entrance aperture 815 through which a portion of the input light from the sample is allowed to pass to the FPI. The NA of the detector may be varied according to the relation:

$$NA \approx tan ( {θ}_{\frac{1}{2}} ) = \frac{{R}_{d} + {R}_{a}}{{R}_{ad}} \qquad ( Eq . 4 )$$

wherein θ_{1/2} is the viewing angle, R_{d} is the width of the detector, Rₐ is the width of the aperture, and R_{ad} is the distance from the aperture to the detector. To enable adjustment of the NA, the aperture layer 810 may be coupled to a movable member to adjust a distance between the aperture layer and the detector, hence changing the NA of the detector. For example, as shown in FIG. 8A, the aperture layer may be positioned at a relatively short distance 812a away from the detector, resulting in a relatively large NA. As shown in FIG. 8B, the aperture layer may be re-positioned via the movable member at a relatively longer distance 812b away from the detector, resulting in a relatively smaller NA. Optionally, alternatively or in addition to the movable aperture layer, the aperture layer may further comprise a means of varying the size of the entrance aperture 815, such as a mechanical or electromechanical shutter disposed over the entrance aperture. As according to Eq. 3, a change in the width of the entrance aperture may change the NA of the detector.

Any FPI-based spectrometer as disclosed herein may comprise an illumination light source that may be modulated to improve the signal-to-noise ratio of the measurement signals generated by the detector. When performing spectroscopy in ambient lighting conditions, the reduction of noise, such as that from ambient light impingent on the detector can be helpful. An approach suitable for reduction of noise is to modulate the illumination light beam at one or more modulation frequencies, and filter the measurement signal generated by the detector for the modulation frequencies of the illumination light beam. By modulating the probe beam at a known frequency, then demodulating the recorded signal using the same frequency as a reference, noise can be reduced. A modulation frequency that is away from one or more noise frequencies, such as frequencies corresponding to ambient light or another known source of noise, can be most effective in producing measurement signals with improved resolution. For example, a typical source of noise such as ambient light changes as well as intrinsic noise sources in the device may have a characteristic 1/f noise curve, with additional noise peaks at 50-60 Hz and integer multiples thereof. Such peaks may be due to flicker at those frequencies, from light sources such as fluorescent or incandescent lighting, for example. Choosing a modulation frequency near such noise peaks will result in a noisier signal, as will choosing low modulation frequency subject to 1/f noise. The illumination light source can be configured to emit illumination light at a modulation frequency that decreases overlap with noise peaks. Circuitry may be coupled to the light source and the detector to modulate the illumination light and filter the detector signal for the desired modulation frequencies.

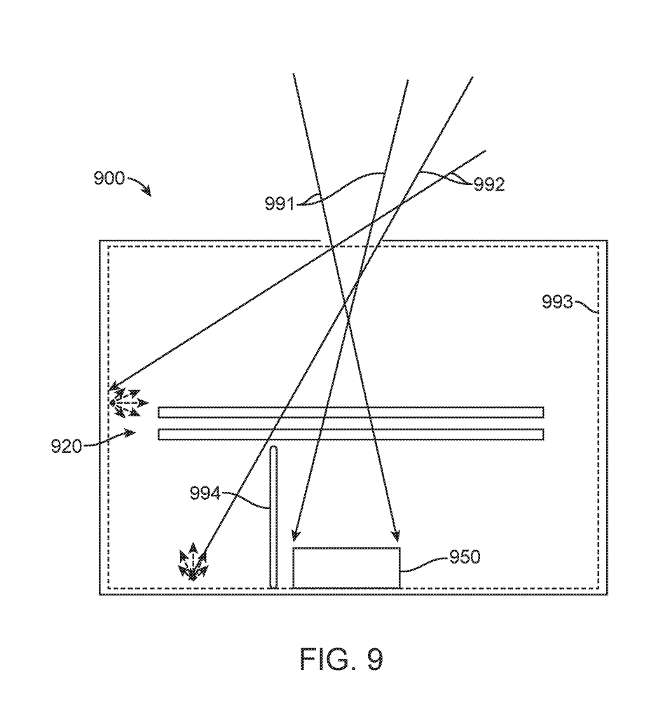

FIG. 9 shows an improved FPI-based spectrometer 900 comprising a case coated with a diffusive black material. The spectrometer 900 may comprise an FPI 920 configured to receive input light from the sample and transmit optically filtered light to a detector 950 configured to measure the optically filtered light transmitted through the FPI. The FPI 920 and the detector 950 may be housed in a case. The FPI 920 may be similar in many aspects to FPI 120 shown in FIGS. 1A-2B and may comprise similar components and features. The detector 950 may be similar in many aspects to detector 150 shown in FIGS. 1A-2B and may comprise similar components and features.

As shown in FIG. 9, light 991 may be the desired light which enters the spectrometer 900 with desired incident angle and reaches the detector through the desired optical path, while light 992 may be the undesired light which enters the spectrometer 900 with undesired angle and reaches the detector not through the desired optical path. The undesired light 992 may reach the detector after one or more reflections at the internal wall of the spectrometer 900. The undesired light may also pass through the filter but in undesired angles that are later scattered toward the detector.

In some embodiments, an internal wall of the case can be coated with a diffusive cover 993 that both absorbs most of the incident light and scatters the rest of it to reduce the energy of multiple reflection rays. The diffusive cover 993 may be made from a light absorbing material or a light diffusive material, such as Acktar. Most of the energy of the undesired light 992 may be absorbed by the diffusive cover 993, and the rest energy can be scattered, such that the reflected undesired light is reduced, and therefore an adverse influence of the undesired light on the detector is reduced.

Alternatively or additionally, baffles 994 may be provided around the detector to prevent undesired light (for example, scattered light or reflected light) to reach the detector 950. Alternatively or additionally, a gap between the detector and the Fabry-Perot interferometer may be encapsulated either by mounting a shield or with an opaque glue.

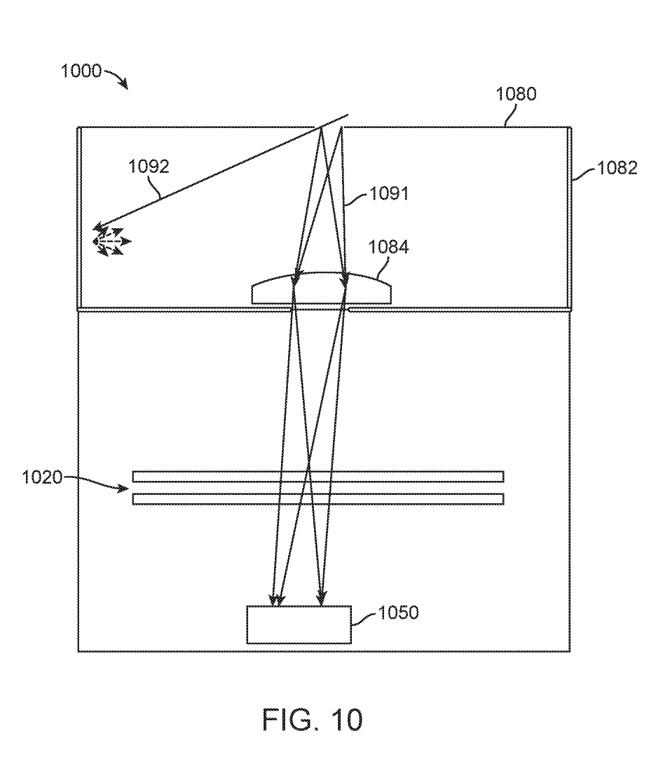

FIG. 10 shows an improved FPI-based spectrometer 1000 comprising additional optomechanics 1080. The spectrometer may comprise an FPI 1020 configured to receive input light from the sample and transmit optically filtered light to a detector 1050 configured to measure the optically filtered light transmitted through the FPI. The FPI 1020 may be similar in many aspects to FPI 120 shown in FIGS. 1A-2B and may comprise similar components and features. The detector 1050 may be similar in many aspects to detector 150 shown in FIGS. 1A-2B and may comprise similar components and features.

The additional optomechanics 1080 may be provided above the spectrometer. The additional optomechanics 1080 may comprise an additional housing 1082 having an upper aperture and a lower aperture, and an additional optics 1084 which is provided to cover the lower aperture. By selecting optical parameters (for example, a focal length) of the additional optics 1084, only desired light 1091 having desired incident angle may pass the a lower aperture of the additional optomechanics 1080 and enter the spectrometer, while undesired light 1092 having undesired incident angle will not enter the spectrometer. In some instances, an inner wall of the additional optomechanics 1080 can be coated with a diffusive cover (not shown) that both absorbs most of the incident light and scatters the rest of it to reduce the energy of multiple reflection rays. The diffusive cover may be made from a light absorbing material or a light diffusive material, such as Acktar. Most of the energy of the undesired light 1092 may be absorbed by the diffusive cover, and the remaining energy can be scattered, such that the reflected undesired light is reduced.

The additional optomechanics may be particularly beneficial for systems with no access to the internal assembly and housing. By adding the additional optomechanics 1080 above the spectrometer, imaging of the additional aperture and controlling of the spot size on the detector plain can be achieved, avoiding additional light from entering the spectrometer. In some instances, an additional micro-louver film can be provided at the upper aperture of the additional optomechanics 1080, such that only light having selected incident angle range can enter the spectrometer. The additional micro-louver film may be similar in many aspects to micro-louver film 370 shown in FIG. 3B and may comprise similar components and features.

One or more of the Fabry-Perot interferometers as described below can be incorporated with one or more embodiments described herein. A Fabry-Perot interferometer may comprise two parallel mirrors, having interference pattern that causes peak transmission at certain discrete wavelength. The transmission wavelengths may correspond to a distance between the two mirrors, related to a multiple of the wavelength. As any integer multiple of the wavelength causes interference, Fabry-Perot filters may have multiple transmission peaks at constant intervals. Spectrometers based on Fabry-Perot interferometers may adjust the distance between the mirrors (for example, using MEMS technology) to scan through a supported spectral range. As each distance correspond to multiple transmission peaks, an external filter may be used to pass only one order of the interferometer. This may limit the spectral range that may be supported by the spectrometers to the interval between adjacent peaks, referred to as FSR (free spectral range).

In some embodiments, two or more photodiodes at close proximity may be provided behind the two mirrors to collect the light that passes through them. Each one of the photodiodes may detect a spectral range which is different from other photodiodes. Optionally, the spectral range detected by the plurality of photodiodes may overlap. For example, two photodiodes, which are in close proximity, may be provided to detect the light. Each one of the two photodiodes may sense one order of the FPI, and together they cover the double spectral ranges during the same scanning period. Optionally, more than two photodiodes, which are in close proximity, may be provided to detect the light. Each one of the plurality of photodiodes may sense one order of the Fabry-Perot interferometers, and together they cover multiple spectral ranges during the same scanning period.

Alternatively or additionally, multiple illumination sources can be used to illuminate the sample. For example, two separate illumination sources may be used, each with a different order-sorting filter covering the spectral range of different orders of the Fabry-Perot interferometers. The two illumination sources may be operated intermittently, with the collected signal corresponding to the order of the operated illumination source at any given time. Alternatively, the two illumination sources may be operated at the same time and modulated to different frequencies. In this case the signal from the photodiode may be filtered by two different band-pass filters to separate the two orders. The band-pass filters can be implemented either with analog circuitry or digitally. Optionally, more than two illumination sources may be used to multiple orders of the Fabry-Perot interferometer. The plurality of illumination sources may be operated intermittently or at the same time and modulated to different frequencies, as discussed hereinabove. The two or more illumination sources may have different spectral range from each other. Optionally, the spectral ranges of the two or more illumination sources may overlap.

Alternatively or additionally, a single illumination source with multiple order sorting filters alternating during the sampling period can be used to illuminate the sample. The single illumination source may cover a full spectral range of the spectrometer. The multiple order sorting filters may be used in an alternating manner so as to filter the spectral range of the light from the sample into single order of the FPI at a time.

Alternatively or additionally, the spectral range can may extended by extending the order sorting filter of the spectrometer to cover multiple orders. In this case, each sampling point may include the sum of the reflected spectrum at multiple discrete wavelengths, matching the number of orders that are passed by the filter. The resulting spectrum may be a sum of two spectra, having different spectral ranges. In this case, the spectrum may not be a typical reflectance spectrum, and may not abide by the beer-lambert law. In other words, typical spectral processing methods may not apply. However, the combined spectrum may include spectral features of the full spectral range transmitted by the filter. Therefore, if a spectral feature of the material exists in either of the transmitted orders, it can be present at the resulting signal. Using non-linear algorithms, the same information may be extracted from the signal, with better chances of having a certain chemical absorption line covered by it.

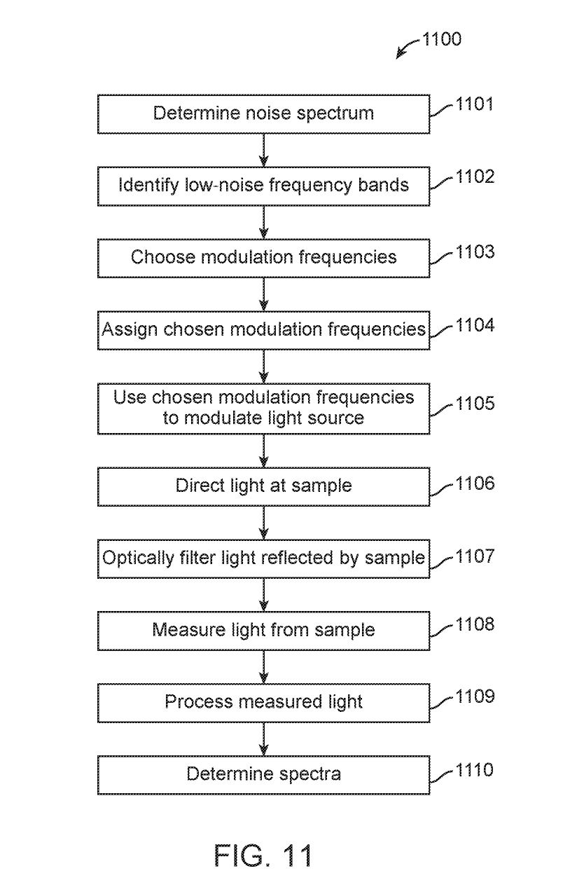

FIG. 11 shows an exemplary method 1100 for improving a measurement signal obtained with an FPI-based spectrometer by modulating the illumination light. The method 1100 comprises measuring a spectrum, by which frequencies may be used to inhibit one or more of ambient noise, intrinsic noise, and other sources of noise. The method 1100 may be performed with any spectrometer as described herein comprising an illumination light source, an FPI, and a detector, further comprising circuitry coupled to the light source and the detector configured to perform at least some of the steps of method 1100. In some embodiments, method 1100 may be performed automatically by a processor associated with a computer readable memory, and coupled to the spectrometer with communication circuitry. In some cases, method 1100 may be performed as calibration step to select modulation frequencies for future use. In still other cases, method 1100 may be performed during operation to determine modulation frequencies based on ambient conditions in use.

In step 1101, a noise spectrum is determined. This determination may be made by performing a fast Fourier transform (FFT) on a plurality of sequential dark frames in which a detector receives only background light. An FFT may be used to generate a noise spectrum in this manner. The frequency resolution of this measurement will be proportional to the number of frames used to generate it; for this reason, it may be desired to record a large number of frames. The noise spectrum may in some cases identify pixel-by-pixel noise spectra, and may in some cases identify noise spectra averaged over a plurality of pixels, including for example all pixels. Further implementations may record data at only a small number of pixels to increase the speed at which frames may be recorded. Alternatively or in combination, the ambient noise spectrum may be generated using measurements from an independent sensor. The noise spectrum generated by step 1101 may relate measured noise as a function of frequency. The sensor data can be transmitted to a remote server and the noise determined and processed with the spectral data remotely, for example. The modulation of the measurement beam can be performed in response to instructions from the remote server, for example. Alternatively, the modulation of the measurement beam may comprise preset instructions to avoid sources of noise as disclosed herein.

In step 1102, one or more frequency bands are identified in which noise is relatively low. These bands may correspond to local minima in the noise spectrum, as can be found for example by a peak finding algorithm. In some cases, the frequency bands may be identified by finding local maxima in the measured noise, then choosing frequencies that are at least a minimum desired distance away from the noise maxima in order to substantially decrease noise. In many cases, it may be preferred to choose a frequency high enough to avoid 1/f noise, and this may be accomplished in many ways, such as designating a band of low frequencies as undesirable, or by weighting a plurality of candidate frequency bands to favor those at higher frequencies. In some cases, certain frequencies may be pre-designated as undesirable; for example, frequencies near certain multiples of 50 or 60 Hz may be designated as undesirable to avoid electronic or light noise due to AC power sources.

In step 1103, a modulation frequency is chosen from one of the identified bands. This choice may be made on a variety of bases, such as choosing the global minimum of noise, or choosing the maximum distance from noise maxima, or choosing among a set of local minima, for example. The chosen frequency may further comprise a set of chosen frequencies, which may be useful, for example, when multiple light sources are to be modulated at different frequencies. When choosing more than one frequency, the chosen frequencies may be selected from a set of frequencies within one band, of from more than one band, and the differences in frequencies may be adjusted to improve accuracy in future demodulation.

In step 1104, the chosen frequencies are assigned to be used in modulation. This assignment may be performed automatically by setting a variable modulation frequency to a chosen frequency, and may in some cases involve an optional user confirmation. This step may also be performed by defining a fixed set of frequencies for future use.

In step 1105, the one or more chosen frequencies are used to modulate one or more light sources, for example, in Frequency Division Modulation. In some cases, the different frequencies may be selected from separate bands, and in some cases one or more frequencies may be selected from the same band.

In step 1106, the illumination light is directed at a sample. This allows the modulated light source to illuminate the sample.

In step 1107, the illumination light reflected by the sample is received by the spectrometer and optically filtered via transmission through a Fabry-Perot interferometer as described herein.

In step 1108, the detector receives and measures the optically filtered light from the Fabry-Perot interferometer. The detector records measurement signals to measure the light from the sample. In some cases, this measurement will comprise a plurality of signals. Data representing these signals may be stored in a memory for processing, processed on-the-fly, or processed remotely.

In step 1109, the associated processor processes the measured light. This step may include one or more demodulation steps for each modulation frequency, to recover a spectrum corresponding to each modulated light source while eliminating noise. This may alternatively or additionally include a step of subtracting a recorded dark frame, or a combination of multiple dark frames, from one or more recorded signals. This step allows the isolation of one or more signals corresponding to one or more light frequencies.

In step 1110, one or more spectra are determined from the signals isolated in step 1109. These spectra may correspond to measured powers at one or more frequencies of emitted and/or scattered light. In some cases, the spectra may be corrected for the relative strengths of different illuminating beams; for example, the amplitudes corresponding to each of a plurality of light sources may be divided by the intensities of each respective light source, and then combined to create a normalized spectrum.

FIG. 11 shows a method 1100 of modulating an illumination light beam to reduce noise in an FPI-based spectrometer as described herein. A person of ordinary skill in the art will recognize many variations, alterations, and adaptations based on the disclosure provided herein. For example, the order of the steps of the method can be changed, some of the steps removed, some of the steps duplicated, and additional steps added as appropriate. Some of the steps may comprise sub-steps. Some of the steps may be automated and some of the steps can be manual. The processor as described herein may comprise one or more instructions to perform at least a portion of one or more steps of the method 1100.

Any FPI-based spectrometer as disclosed herein may comprise an illumination light source whose operational parameters may be monitored over time for any temporal deviations. Temporal deviations in the output of the illumination light source may be used as feedback to adjust the operation of the light source and/or adjust a measurement signal generated by the detector to compensate for the detected temporal deviations.

For example, a spectrometer as disclosed herein may further comprise a temperature sensor operably coupled with the light source and configured to monitor a temperature of the light source over time. Alternatively or in combination, a spectrometer as disclosed herein may comprise one or more detectors such as photodiodes configured to measure at least a portion of the illumination light produced by the light source, and measure the spectra of the illumination light over time. For example, the spectrometer may comprise two photodiodes placed in the optical path of the illumination light directed from the light source to the sample, a first photodiode optically coupled with a short pass filter and a second photodiode optically coupled with a long pass filter. The first photodiode can measure short-wavelength illumination light and the second photodiode can measure long-wavelength illumination light, such that data from the two detectors can be used as a degenerated spectral measurement of the illumination light. Both the total power of the output light and the ratio of the long-wavelength to short-wavelength power output can be tracked over time to estimate temporal deviations in the emitted spectra of the light source. Alternatively or in combination, a spectrometer as disclosed herein may comprise a voltage meter operably coupled with the light source and configured to measure a voltage drop across the light source over time.

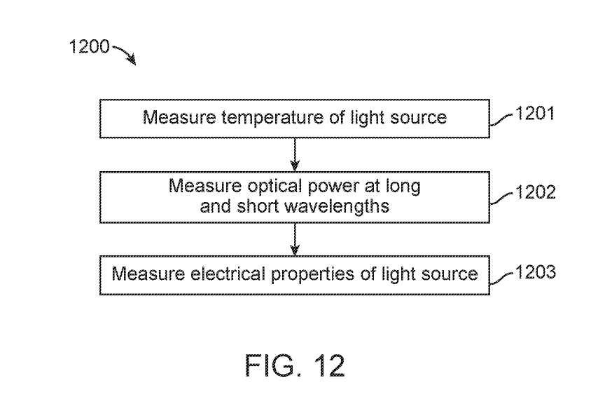

FIG. 12 shows an exemplary method 1200 for tracking temporal deviations of the illumination light source of an FPI-based spectrometer. The method 1200 comprises measurements of the light source of the FPI-based spectrometer in order to correct for instabilities in the light source. The method 1200 may be performed with any spectrometer as described herein comprising an illumination light source, an FPI, and a detector, further comprising circuitry coupled to the light source and the detector configured to perform at least some of the steps of method 1200. In some embodiments, method 1200 may be performed automatically by a processor associated with a computer readable memory, and coupled to the spectrometer with communication circuitry.

In step 1201, fluctuations in the temperature of the light source may be measured over time with a temperature sensor operably coupled to the light source. As the temperature of the light source is highly correlated with its emission spectrum, temperature may serve as a useful parameter to be measured for correcting deviations over time. The temperature sensor may measure the temperature of the light source through physical contact with the light source. For instance, a thermistor may be in contact with a surface of the light source. The temperature sensor may measure the temperature of the light source remotely. For example, an infrared temperature sensor might detect the temperature of the light source from a distance. Multiple temperature sensors may be utilized to obtain a more accurate measurement of the temperature of the light source or to obtain a higher sampling frequency of the temperature.

In step 1202, the optical power of the illumination light may be measured at both long and short wavelengths. The use of two measurements may allow the determination of both the total power emitted by the light source and the ratio of longer wavelengths to shorter wavelengths. This information may be combined with a prior calibration of the light source to accurately estimate the spectrum emitted by the light source. These measurements may then be applied to correct for instabilities in the output spectrum. The measurements may be accomplished using two photodiodes, one with a short pass filter and one with a long pass filter. More than two wavelengths may be monitored to allow for greater accuracy.

In step 1203, the driving voltage or current across the light source may be measured. The light source may be interfaced with a current or voltage measuring device in such a manner as to allow a measurement of the driving voltage or current. The electrical operating parameters of the light source may be highly correlated with the temperature and emission spectrum of the light source.

FIG. 12 shows a method 1200 of tracking temporal deviations in the output of the illumination light source. A person of ordinary skill in the art will recognize many variations, alterations, and adaptations based on the disclosure provided herein. For example, the order of the steps of the method can be changed, some of the steps removed, some of the steps duplicated, and additional steps added as appropriate. Some of the steps may comprise sub-steps. Some of the steps may be automated and some of the steps can be manual. The processor as described herein may comprise one or more instructions to perform at least a portion of one or more steps of the method 1200.

Any FPI-based spectrometer as described herein may comprise a tunable FPI that may be adjusted to scan through a sequence of central wavelengths of light, in order to generate spectra of the sample light. Measurement using an FPI-based spectrometer may be optimized by selecting scan patterns that are best suited for specific applications. The scanning may be performed automatically by a processor associated with a computer readable memory, and coupled to the spectrometer with communication circuitry.

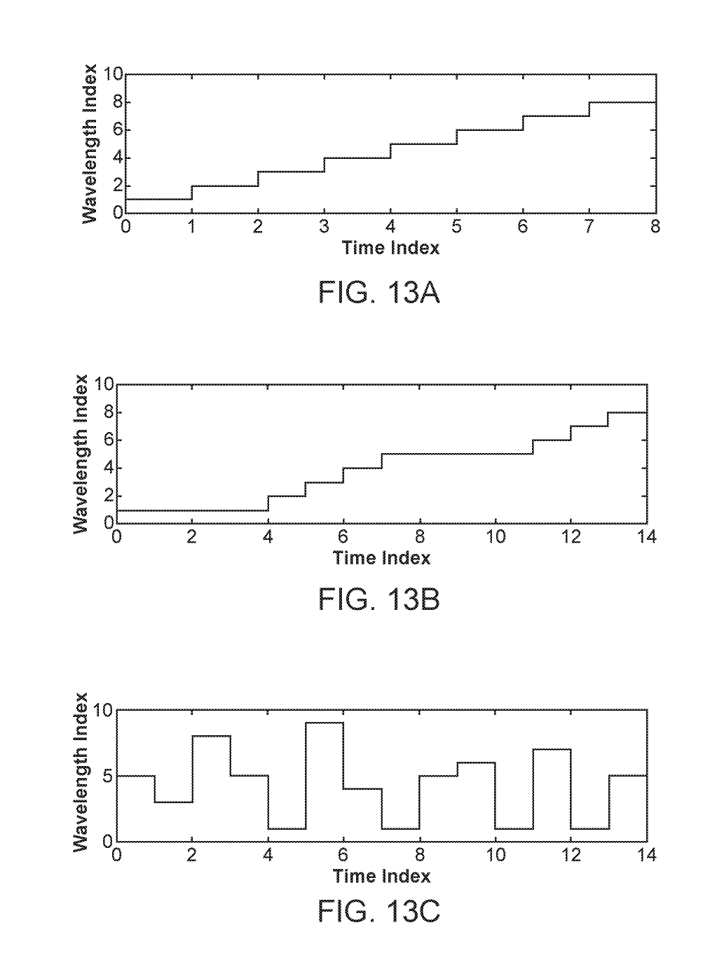

In general, sampling time may be reduced by scanning through only the wavelengths relevant to a specific application. For example, while the total available scanning range for the FPI-based spectrometer may be {λₛₜₐᵣₜ−λ_{end}}, the desired spectral ranges for a specific application may be {λₐ−λ_{b}, λ_{c}−λ_{d}}. The FPI may be configured to scan through a scan sequence that comprises a permutation of {λₐ−λ_{b}, λ_{c}−λ_{d}}, wherein the scan sequence may include several repetitions of a reference wavelength that requires improved SNR. Each wavelength may be sampled with the minimum integration time possible considering limitations of the readout circuitry, the dynamic range of the system, etc. Each scan sequence, such as those shown in FIGS. 13A-13C, may be repeated as many times as required for a specific application.

FIG. 13A shows an exemplary scan patterns for obtaining sample spectra using an FPI-based spectrometer. Due to the scanning nature of the FPI, spectra must be collected in a point-by-point manner, with the spectral response to each illumination wavelength obtained separately. In some cases, it may be necessary to utilize a signal-averaging technique, in which multiple measurements at made at a single wavelength, in order to obtain a sufficient signal-to-noise ratio (SNR). As shown in FIG. 13A, this may be accomplished by incrementing the wavelength in a consecutive order and collecting the same number of samples at each wavelength.

FIG. 13B shows another exemplary scan pattern for obtaining sample spectra using an FPI-based spectrometer. The spectral response to each wavelength may vary, as may the noise figure at each wavelength. This may lead to a single-scan SNR which varies with wavelength. In order to minimize the total amount of time performing measurements, signal averaging may only be applied to the extent necessary to obtain a sufficient SNR at each wavelength. For instance, as shown in FIG. 11B, obtaining sufficient SNR at the wavelength index 1 may require averaging 4 single-scan acquisitions, while a sufficient SNR may be obtained at wavelength index 2 with a single scan. By applying signal averaging at each wavelength only to the extent required to obtain sufficient SNR at that wavelength, the overall signal acquisition time may be greatly reduced.

FIG. 13C shows another exemplary scan pattern for obtaining sample spectra using an FPI-based spectrometer. The SNR at each frequency may be subject to temporal variations due to, for instance, fluctuations in the output of the light source, changes in ambient temperature, or vibrations. By imparting a time dependence to the measurements at each wavelength, it may become possible to derive additional information about these temporal variations or to correct for them. This may be implemented in a measurement scheme. The same wavelength may be measured repeatedly at a variety of different times throughout the measurement. For instance, wavelength index 1 may be measured near the beginning, middle, and end of the overall measurement sequence in FIG. 13C. The wavelengths may generally be measured in a non-consecutive manner. This manner may be deterministic or stochastic. The measurement at each wavelength may be repeated as many times as is necessary to achieve a sufficient SNR.

In addition or alternatively to the scan sequences shown in FIGS. 13A-13C, a semi-random scan pattern may be used, wherein the desired spectral range for a specific application may be scanned at predefined, non-continuous intervals. Assuming that the spectrum is smooth, neighboring wavelengths that are sampled at non-consecutive time intervals will produce a non-smooth time series if there are temporal deviations in the measurements of the wavelengths. The resultant spectra may be analyzed and corrected algorithmically to compensate for the temporal deviations and produce a smooth spectrum.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A spectrometer for measuring spectra of a sample, the spectrometer comprising:
a Fabry-Perot interferometer configured to selectively transmit optically filtered light having a predetermined central wavelength;
a detector configured to receive the optically filtered light from the Fabry-Perot interferometer and measure an intensity of the optically filtered light; and
an angle-limiting layer disposed between the sample and the Fabry-Perot interferometer, the angle-limiting layer configured to receive light from the sample and transmit light having an angle of incidence within a predetermined range.

2. The spectrometer of claim 1, wherein the angle-limiting layer comprises a micro-louver film having a plurality of light transmissive sections and a plurality of light blocking sections arranged alternating along a length of the micro-louver film, wherein one or more of a thickness of the micro-louver film and a distance between adjacent light blocking sections are configured to selectively transmit the light having the angle of incidence within the predetermined range.

3. The spectrometer of claim 1, wherein the angle-limiting layer comprises a prism film having an input surface configured to receive light and an output surface configured to output the light, the output surface comprising a plurality of microstructures configured to modify an angle of transmission of the output light, such that the output light comprises the light having the angle of incidence within the predetermined range.

4. The spectrometer of claim 1, further comprising a diffuser layer disposed between the sample and the angle-limiting layer, the diffuser layer configured to spatially distribute the light from the sample substantially evenly across an area of the angle-limiting layer.

5. The spectrometer of claim 1, further comprising a lens disposed between the Fabry-Perot interferometer and the detector, the lens configured to direct the optically filtered light towards the detector.

6. A spectrometer for measuring spectra of a sample, the spectrometer comprising:
a light source configured to emit illumination light towards the sample;
a Fabry-Perot interferometer disposed between the light source and the sample, the Fabry-Perot interferometer configured to selectively transmit optically filtered illumination light having a predetermined central wavelength; and
a detector configured to receive a portion of the optically filtered illumination light reflected by the sample, and measure an intensity of the reflected light.

7. The spectrometer of claim 6, wherein the light source comprises a broadband light source, and wherein the detector comprises a broadband detector.

8. The spectrometer of claim 7, wherein the Fabry-Perot interferometer is configured to scan through a plurality of predetermined central wavelengths of the illumination light to illuminate the sample with a series of optically filtered illumination light beams having the plurality of predetermined central wavelengths.

9. The spectrometer of claim 6, further comprising a lens disposed between the light source and the Fabry-Perot interferometer, the lens configured to direct the illumination light towards the Fabry-Perot interferometer.

10. The spectrometer of claim 6, further comprising a second detector and a beam splitter, the beam splitter disposed between the Fabry-Perot interferometer and the sample and configured to transmit a first portion of the optically filtered illumination light towards the sample and reflect a second portion of the optically filtered illumination light away from the sample and towards the second detector, and the second detector configured to measure an intensity of the second portion of the optically filtered illumination light.

11. The spectrometer of claim 10, further comprising a processor operably coupled with the light source and the second detector, and configured with instructions to calibrate the light source in response to the intensity of the second portion of the optically filtered illumination light measured by the second detector.

12. A spectrometer for measuring spectra of a sample, the spectrometer comprising:
a Fabry-Perot interferometer configured to receive light from the sample and selectively transmit optically filtered light having a predetermined central wavelength; and
a plurality of detectors configured to receive the optically filtered light transmitted through the Fabry-Perot interferometer, each detector of the plurality of detectors configured to receive a portion of the optically filtered light that is different from portions of the optically filtered light received by other detectors of the plurality of detectors.

13. The spectrometer of claim 12, wherein each detector of the plurality of detectors has a size that is different from other detectors of the plurality of detectors to receive the portion of the optically filtered light that is within a range of incident angles that is different from ranges of incident angles of the portions of the optically filtered light received by other detectors of the plurality of detectors.

14. The spectrometer of claim 12, wherein the plurality of detectors is disposed overlappingly in an optical path of the optically filtered light transmitted through the Fabry-Perot interferometer.

15. The spectrometer of claim 12, wherein the plurality of detectors is disposed non-overlappingly in an optical path of the optically filtered light transmitted through the Fabry-Perot interferometer.

16. The spectrometer of claim 15, further comprising a plurality of angle-limiting layers disposed between the Fabry-Perot interferometer and the plurality of detectors, each angle-limiting layer of the plurality of angle-limiting layers operably coupled to each detector of the plurality of detectors and configured to selectively transmit optically filtered light having an incidence angle within a predetermined range that is different from predetermined ranges of incident angles selectively transmitted by other angle-limiting layers of the plurality of angle-limiting layers.

17. The spectrometer of claim 15, wherein each detector of the plurality of detectors is configured to receive the portion of the optically filtered light that comprises a wavelength that is different from wavelengths of the portions of the optically filtered light received by other detectors of the plurality of detectors.

18.-62. (canceled)
